(19) United States
(12) Patent Application Publication
(10) Pub. No.: US 2026/0091580 A1
(43) Pub. Date: Apr. 2, 2026

(54) Media Processing Device with Media Gap Detection

(71) Applicant: ZEBRA TECHNOLOGIES CORPORATION, Lincolnshire, IL (US)

(72) Inventors: Zi Yang, Guangzhou (CN); Songbai Liu, Guangzhou (CN); Jinqiang Huang, Guangzhou (CN); Yunbo Yuan, Guangzhou (CN)

(21) Appl. No.: 18/899,656

(22) Filed: Sep. 27, 2024

(51) Int. Cl. B41J 2/045

(52) U.S. Cl. CPC B41J 2/04556; B41J 2/0457

(57) ABSTRACT

A media processing device including a platen, a printhead configured to form a nip with the platen, a sensor disposed proximate to the printhead, a detector configured to receive a sensor output from the sensor, and a logic circuit. The sensor is configured to be responsive to demarcation features on a media supply as the media supply is advanced along a feed path past the sensor by the platen. The detector is configured detect edges of the demarcation features, and output a detector output based on the detected edges. The logic circuit is configured to receive the detector output from the detector, determine when to print based on the detector output, and control the printhead and the platen to print on the media unit or printable area.

### BACKGROUND

Media calibration and/or registration is often required for media processing devices to ensure the media is processed in a desired manner. As an example, when printing labels, media calibration and/or registration can be required to ensure that the printer prints indicia at the desired location on each label. However, in some instances, the processing and recognition of demarcation features used for calibration and/or registration can be complicated and/or inaccurate.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram that illustrates an example media processing device in accordance with embodiments of the present disclosure.

FIG. 2A is an example of a subset of components of the media processing device shown in FIG. 1 in accordance with embodiments of the present disclosure.

FIG. 2B is another example a subset of components of the media processing device shown in FIG. 1 in accordance with embodiments of the present disclosure.

FIG. 3 is an example of an embodiment of a detector of the media processing device shown in FIG. 1.

FIG. 4 is a block diagram that illustrates another example embodiment of a detector that includes two signal processing paths.

FIG. 5 illustrates an example operation of an example embodiment of an embodiment of the detector.

FIG. 6 illustrates another example operation of an example embodiment of the detector.

FIG. 7 is a flowchart illustrating an example process in accordance with embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The components of embodiments of the present disclosure have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Embodiments of media processing devices of the present disclosure can process (e.g., print, encode, etc.) media by drawing the media from the media source and routing the media proximate various processing components (e.g., printhead, RFID reader/encoder, magnetic stripe reader/encoder etc.). Processing the media from the media source may facilitate a continuous or batch printing process. As an example, embodiments of media processing devices of the present disclosure can be configured to print and/or encode media drawn from a media source, such as roll, spool, or fanfold. Such media can include a continuous web such as a spool of liner-back media or linerless media. In some embodiments, the media can include individual labels disposed on a continuous liner web or substrate. In some embodiments, the media can be linerless. Some non-limiting examples of media include labels and wristbands. For thermal transfer printing, the printable surface of the media is configured to receive a pigment (e.g., ink, resin, wax-resin, etc.) that is transferred from a ribbon supply. For direct thermal printing, a thermal printhead of the printer directly contacts the printable surface triggering a chemical and/or physical change in a thermally sensitive dye covering and/or embedded in at least a portion of the printable surface of the media.

The media is routed along a feed path from the media supply to a print position located adjacent to the printhead (e.g., a thermal printhead). The media can be pulled through the feed path by a platen roller driven by a motor, where an operation of the motor is controlled by a logic circuit. In some examples, the printhead can be generally configured to form a nip with the platen roller to pinch the media between the printhead and the platen roller. For thermal printing applications, this pinching or compressive force provides for adequate print quality, and in some applications, ensures that a sufficient tension is maintained the continuous web. Once printed via the printhead, the printed portion of the media is advanced outwardly from the printer through a media outlet by, for example, the platen roller, where the printed media can be peeled from the liner, cut, and/or torn to separate the printed media from the media supply.

Embodiments of the media processing device can accommodate different types of media. As one example, embodiments of the media processing device can process different labels having different dimensions and/or can process wristbands having different dimensions. There can be significant variation between different media supplies (and even between different media supplies of the same type or model of media), e.g., due to variations and tolerances in the manufacturing processes of the media supplies. To accommodate different types of media supplies, embodiments of the media processing device can calibrate the media, for example, when the media is loaded into the media processing device and/or when the media processing device is powered on. A sensor can be included in the media processing device that is configured to respond to demarcation features formed on or by the media, which can be used by the media processing device to detect when the demarcation features have been sensed by the sensor and subsequently perform the media calibration based on the detection of the demarcation features. One approach for detecting a demarcation feature uses thresholding, which can require that the sensor parameters be adjusted (e.g., emitter strength and receiver gain) to obtain a specified response to the demarcation features that satisfies a programmed threshold value. Using this approach, thresholding for media calibration relies on the detection of multiple demarcation features in the media supply, which can increase the time required for media calibration and/or can generate waste where unused media is output from the media processing device. In addition, due to variations in the media supply, some of the demarcation features in the media supply may have significantly different parameters such that the response of the sensor to these variations in demarcation features may not satisfy the programmed threshold.

To overcome the issues associated with media calibration that relies on thresholding for the detection of demarcation features, embodiments of the present disclosure can include a detector circuit that receives a sensor output from the sensor and outputs a detector output to a logic circuit of the media processing device that indicates a demarcation feature has been detected. The detector can perform parallel processing of the sensor output using at least two parallel signal processing paths, where the outputs of the parallel signal processing paths are compared to each other to determine whether a demarcation feature has been detected. Using this approach, a fail-rate for the detection of demarcation features can be reduced to zero or near zero. Additionally, embodiments of the detector can alleviate the need for media calibration because the detector tracks the signal transient of the sensor output and not the absolute strength/value, which is required when using thresholding, and/or can be resilient to false detections dues to electrical and/or optical noise inserted into the sensor.

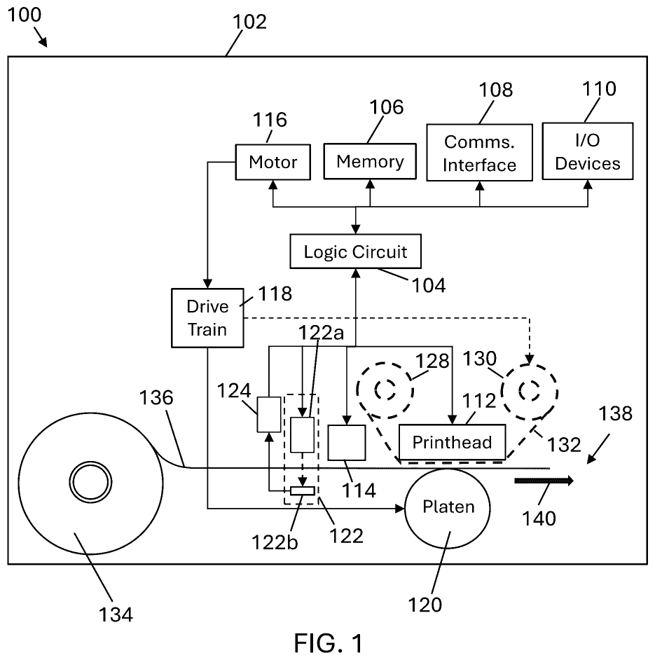

FIG. 1 illustrates a block diagram of an example media processing device 100, such as a printer, in accordance with embodiments of the present disclosure. The media processing device 100 can include a housing 102. The housing 102 contains or supports one or more components of the media processing device 100 including, for example, a logic circuit 104, memory 106, a communication interface 108 (e.g., for wired and wireless communication), input/output (I/O) devices 110 (e.g., a display, switches, buttons, speakers, microphone, etc.), a printhead 112, a radiofrequency encoder/reader 114, a motor 116, a drive train 118, a platen roller 120, a sensor 122, e.g., formed by an emitter 122a and a receiver 122b, and a detector 24. The printhead 112 and the platen roller 120 can form a nip. In some embodiments, e.g., for thermal transfer printing, the media processing device 100 can include a ribbon supply spindle 128 and a ribbon take up spindle 130 for supporting an ink ribbon 132. For direct thermal embodiments, the media processing device 100 can be devoid of the ribbon supply spindle 128, the ribbon take-up spindle 130, and the ink ribbon 132. The housing 102 can also be configured to contain a media supply 134. As an example, the housing 102 can include a media chamber to store the media supply 134 as it is consumed by the media processing device 100. The logic circuit 104 can include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. The memory 106 is a non-transitory computer-readable medium that can include, for example, volatile (e.g., RAM, DRAM, SRAM, etc.) and/or non-volatile memory (e.g., ROM, PROM, EPROM, EEPROM, Flash memory device, optical memory device, magnetic memory device).

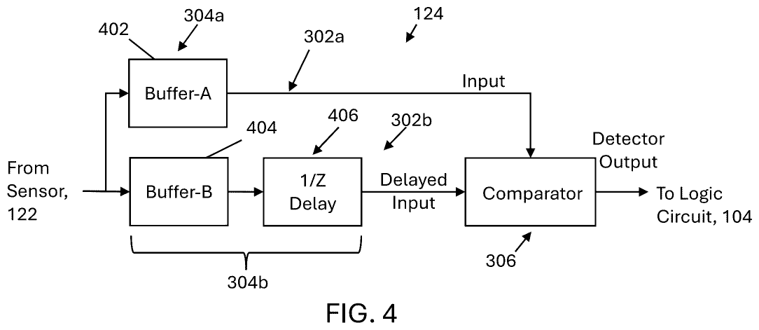

The logic circuit 104 of the media processing device 100 can be operatively coupled to the memory 106, the communications interface 108, the I/O devices 110, the printhead 112, the radiofrequency encoder/reader 114, the motor 116, the sensor 122, and/or the detector 124. The platen roller 120 can be driven by the motor 116 via a drive train 118 to rotate the platen roller 120 about an axis of rotation in a first direction (e.g., clockwise in the orientation shown in FIG. 1) to pull the media 136 through the feed path in a direction indicated by arrow 140 and output the media from the media processing device via a media exit 138 formed in the housing 102 and can be driven by the motor 116 via the drive train 118 to rotate the platen roller 120 about the axis of rotation in a second direction (e.g., counterclockwise in the orientation shown in FIG. 4) to retract the media 136 (in an opposite direction than the arrow 140). In one example, the logic circuit 104 can be configured to execute code stored in the memory 106 to perform operations and functions of the media processing device 100, e.g., by communicating with and/or controlling one or more of the components of the media processing device 100. The logic circuit 104 can execute the code stored memory 106 to implement a printing operation or function that controls the motor 116 to rotate the platen roller 120 to feed the media 136 past the printhead 112, controls the print head 112 to print on the media 136 (either directly or by transferring an ink from a ribbon to the media), and/or controls the RF encoder/reader 114 to encode and/or read radiofrequency circuits (e.g., RFID or NFC tags or inlays) included in or on the media 136. For thermal transfer printing, the printable surface of the media 136 is configured to receive a pigment (e.g., resin, wax-resin, etc.) that is transferred from the ink ribbon 132 installed on the ribbon supply and take-up spindles 128 and 130, respectively, via an operation of the printhead 112. For direct thermal printing, the printhead 112 of the media processing device 100 can selectively heat the printable surface of the media 136 triggering a chemical or physical change in a thermally sensitive dye covering at least a portion of the printable surface of the media 136. After printing on the media 136, the media can be further advanced and output from media processing device 100 by the operation of the platen roller 120.

To ensure the printhead 112 prints at specified or desired locations on the media 136 as the media 136 passes the printhead 112, the logic circuit 104 can be configured to calibrate the media 136 relative to the printhead 112 and/or to register the media 136 relative to the printhead 112, e.g., by identifying a designated printing area on the media 136 and the logic circuit 104 can control the printhead 112 to print on the designated printing area of the media. To facilitate to the identification of the designated printing areas, the media 136 may include demarcation features that can be used to locate the designated printing areas. In some instances, the demarcation features can include black marks or other indicia to indicate the designated printing areas, can include gaps between discrete media units to indicate the designated printing areas, and/or can include notches in the media. As an example, the media 136 can include a continuous web of discrete labels or wristbands, where the web or the labels/wristbands can include indicia (e.g., black marks) to demarcate adjacent labels/wristbands along a length the web. As another example, the discrete labels can be spaced apart from each other on the web such that a gap exists between adjacent labels along a length of the web of (transparent or translucent) liner where the gaps can demarcate the adjacent labels along the length of the web. As an example, the media 136 can include a continuous web of labels or wristbands, where the web or the labels/wristbands can include notches to demarcate adjacent labels/wristbands along a length the web. These demarcation features can be used to identify leading edges and/or trailing edges of the labels and/or can be used to calibrate and/or register the media relative to the printhead to ensure that the logic circuit 104 controls the printhead 112 to print on the media at a specified and/or desired location (e.g., in the printing area based on a print command and/or print data).

The sensor 122 can be configured to respond to the demarcation feature between media units and to output a sensor output to the detector 124 representative of the response to the demarcation feature. In the present example embodiment, the sensor 122 includes the emitter 122a and the receiver 122b configured in a transmissive sensor configuration. However, in other example embodiments, the emitter 122a and the receiver 122b can be configured in a reflective sensor configuration. The sensor 122 can be an optical sensor, where the emitter 122a can be, for example, a photodiode that emits electromagnetic energy in the light spectrum (e.g., a light signal) and receiver 122b can be a photodetector that detects the presence or absence of the emitted electromagnetic energy (e.g., the light signal) impinging on the receiver 122b and/or can detect variation in the intensity or power of the electromagnetic energy (e.g., the light signal) impinging on the receiver 122b. The sensor 122 can continuously output the sensor output. The sensor output can have a first range of output values between demarcation features and can have a second range of output values when demarcation features are detected. In some instances, there can be significant variation in the output values of the sensor output between detection of demarcation features and/or between different media supplies (even between different media supplies of the same type or model of media), e.g., due electrical and/or optical noise inserted into the sensor, due to variations and tolerances in the manufacturing processes of the media. Due to such variation, conventional approaches which typically use thresholding to distinguish between the first range of values and the second range of values of the senor output, can be impractical, inaccurate, or otherwise require complicated firmware algorithms, which can negatively impact the ability of the media processing device to effectively and efficiently calibrate and/or register the media 136 relative to the printhead 112.

In accordance with embodiments of the present disclosure, the detector 124 can continuously receive the sensor output from the sensor 122 (e.g., an electrical signal from the receiver 122b) that is representative of the presence or absence of the light signal impinging on the receiver 122b and/or that is representative of the intensity or power of the light signal impinging on the receiver 122b. The detector 124 can be implement in hardware as circuitry that includes signal processing circuitry. In response to receiving the sensor output from the sensor 122, the detector 124 can process the sensor output and generate a detector output that includes pulses corresponding to the detection of the demarcation features as the media is being advanced past the sensor 122 (e.g., via an operation of the platen 120). The detector output generated by the detector 124 can be output by the detector 124, to the logic circuit 104 and the pulses in the detector output can identify the demarcation features, which can be used by the logic circuit to locate leading of media units (e.g., a label or wristband) or printable area of the media units and/or trailing edges of the media units or printable areas of the media units and/or can be used to calibrate and/or register the media 136 relative to the printhead 112 without having to specify a threshold and/or without relying on software algorithms for the detection of demarcation features. In one example, at least one edge of a pulse included in the detector output can align with a leading edge of a media unit (e.g., a label or wristband) or pintable area of a media unit and/or can align with a leading edge of a demarcation feature. Alternatively, or in addition, in one example, at least one edge of a pulse included in the detector output can align with a trailing edge of a media unit (e.g., a label or wristband) or printable area of the media unit and/or can align with a trailing edge of a demarcation feature.

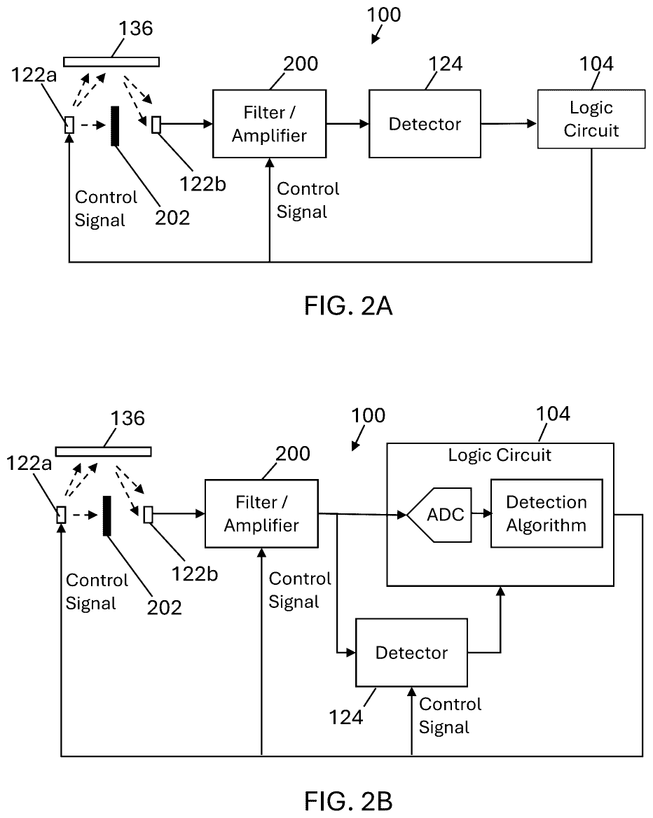

FIG. 2A illustrates a block diagram that shows a subset of components of an embodiment of the media processing device 100 in accordance with embodiments of the present disclosure. As shown in FIG. 2A, the logic circuit 104 can output one or more control signals (e.g., in the form of pulse width modulated signals) to the emitter 122a to control the light signal output by the emitter and/or to control a response and/or gain of a filter/amplifier circuit 200. The sensor 122 illustrated in the present example is a reflective sensor configuration where a light barrier 202 prevent the light signal output from the emitter 122a from directly impinging upon the receiver 122b. The receiver 122b can output the sensor output to the filter/amplifier circuit 200, which can condition the sensor output for processing by the detector 124. In some examples, the filter/amplifier circuit 200 can be incorporated into the detector 124. The detector 124 can output the detector output including pulses to demarcate edges of media units, printable areas, and/or demarcation features to the logic circuit 104 and the logic circuit 104 can use the pulse in the detector output to identify the leading edges and/or trailing edges of the media units, printable areas, or demarcation features.

FIG. 2B illustrates a block diagram that shows a subset of components of another embodiment of the media processing device 100 in accordance with embodiments of the present disclosure. As shown in FIG. 2B, the logic circuit 104 can output one or more control signals (e.g., in the form of pulse width modulated signals) to the emitter 122a to control the light signal output by the emitter, to control a response and/or gain of a filter/amplifier circuit 200, and/or to control the detector 124. The sensor 122 illustrated in the present example is a reflective sensor configuration where a light barrier 202 prevent the light signal output from the emitter 122a from directly impinging upon the receiver 122b. The receiver 122b can output the sensor output to the filter/amplifier circuit 200, which can condition the sensor output for processing by the detector 124. In some examples, the filter/amplifier circuit 200 can be incorporated into the detector 124. Similar to FIG. 2A, the detector 124 can output the detector output including pulses to demarcate edges of media units, printable areas, or demarcation features for the logic circuit 104 and the logic circuit 104 can use the pulse in the detector output to identify the edges of the media units, printable areas, or demarcation features. Additionally, the logic circuit 104 can receive the sensor output conditioned by the filter/amplifier 200 in parallel with the detector output. The sensor output can be digitized by an analog-to-device converter (ADC) 210 and the digitized sensor output can be processed by a detection algorithm, which can determine identify the edges of the labels, or demarcation features via one or more functions. As one example, the logic circuit 104 can use a combination of the detector output and an output of the detection algorithm to identify and/or validate the detection of the edges of the labels or demarcation features. As another example, the logic circuit 104 can switch between the detector 124 and the detection algorithm. The logic circuit 104 can begin print job relying on the detector output from the detector 124 to print on media units. Meanwhile, the detection algorithm can be used perform a calibration using thresholding in background, and after the calibration is complete, the logic circuit 104 can switch from using the detector output to using the output of the detection algorithm for a remainder of the print job.

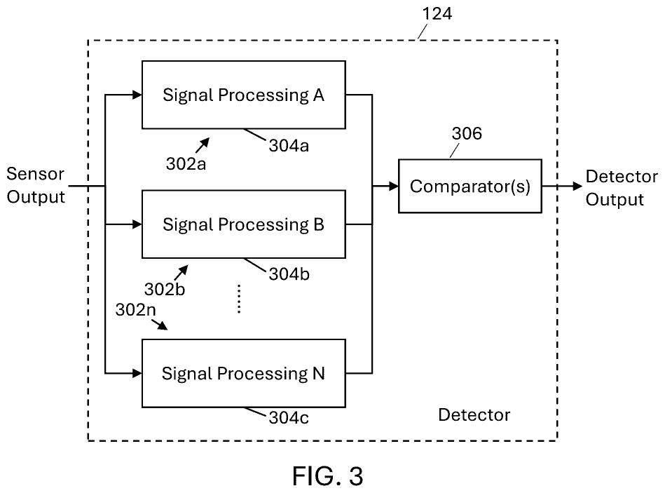

FIG. 3 is an example of an embodiment of the detector 124 of the media processing device 100 shown in FIG. 1. The detector 124 can include two or more signal processing paths 302a-n that operate in parallel to each other to process the sensor output. Each of the signal processing paths 302a-n can include signal processing circuits 304a-n that receive the sensor output as an input and that output processed signals to one or more comparators 306. The signal processing circuits 304a-n can be different from each other and/or include different parameters such that the outputs of the signal processing circuits 304a-n generate different from each other and the output of at least one of the signal processing circuits 304a-n is different from the sensor output. In one example, the output of at least one of the signal processing circuits 304a-n can be substantially similar to the sensor output. In one example, one of the parallel paths 302a-n can be devoid of a signal processing circuit such that the sensor output can be input directly to the one or more comparators 306. The one or more comparators 306 can compare the processed signals (and in some examples, the processed signal(s) and the sensor output) and can output the detector output.

FIG. 4 is a block diagram that illustrates another example embodiment of the detector 124 that includes two signal processing paths 302a and 302b. The signal processing path 302a includes signal processing circuit 304a in the form of a buffer 402 (e.g., an analog buffer amplifier, unity-gain amplifier, or voltage follower) such that a buffered version of the sensor output (e.g., a first version of the sensor output or first intermediate signal) is output on the signal processing path 302a and input to the comparator 306. The signal processing path 302b includes the signal processing circuit 304b which includes a buffer 404 (e.g., an analog buffer amplifier, unity-gain amplifier, or voltage follower) and a delay circuit 406 such that a buffered and delayed version of the sensor output (e.g., a second version of the sensor output or second intermediate signal) is output on the signal processing path 302b and input to the comparator 306. In some embodiments, the delay circuit 406 can be a low-pass filter. The comparator 306 compares the first and second versions of the sensor output and outputs the detector output to the logic circuit 104 based on the comparison. While the example embodiment illustrated in FIG. 4 depicts analog signal processing, embodiments of the present disclosure can digitize the sensor output (using an analog-to-digital converter) and utilize digital signal processing algorithms and/or circuits implemented by the logic circuit 104 or another logic circuit, where the digital signal processing algorithms and/or circuits are analogous to the illustrated analog signal processing circuits.

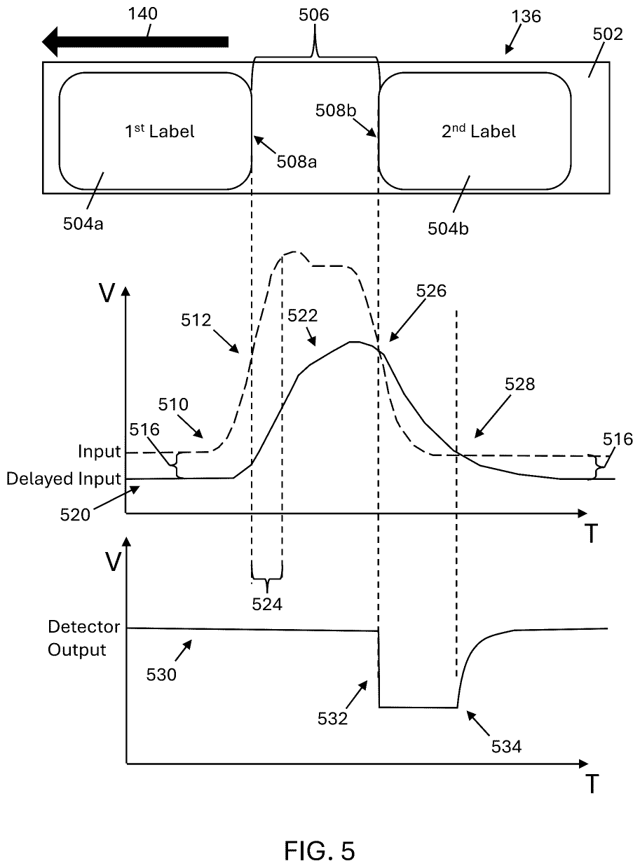

FIG. 5 illustrates an example operation of an example embodiment of the detector 124 shown in FIG. 4. An example of the media 136 is shown that includes a continuous liner/substrate 502 with discrete media units, e.g., labels 504a and 504b, providing printable areas. The media 136 is advanced along a print path in the direction indicated by arrow 140 such that the label 504a passes the sensor 122 first and the label 504b passes the sensor after the label 504a. The sensor 122 can be used detect a gap 506 between the labels 504a and 504b. For example, as the media 136 is advanced, a trailing edge 508a of the label 504a aligns with the sensor and then passes the sensor in the direction indicated by the arrow 140. In one example, the light signal output by the emitter of the sensor 122 is blocked or substantially attenuated such that the receiver of the sensor does not detect the light signal or detects the light source with a substantially low intensity (e.g., the receiver detects light within a first range of values).

As the media is advanced and the gap 506 aligns with the sensor 122, the light signal output by the emitter of the sensor 122 passes through the liner, which can be transparent or translucent, and impinges upon the receiver of the sensor 122 (e.g., the receiver detects light within a first range of values). As a result, the sensor output forms a waveform generates a pulse, which in the present example, is an increase in the voltage output by the receiver in response to the light signal passing through the liner 502 and impinging upon the receiver. The sensor output is processed in parallel by the buffer 402 of the signal processing path 302a and by the buffer 404 and the delay 406 of the signal processing path 302b. The output of the buffer 404 generates an input waveform 510 and the output of the buffer 404 and the delay 406 generates a delayed input waveform 520 which correspond to the input waveform but is delayed by a time delay 524 (which may correspond to a phase shift from the input waveform to the delayed input waveform). A width of a pulse 512 of the input waveform generally corresponds to a time it takes the media to be advanced from a point where the trailing edge 508a of the label 504a aligns with the sensor 122 (a rising edge of the pulse 512) to a point where the leading edge 508b of the label 504b aligns with the sensor 122 (a falling edge of the pulse 512), while a pulse 522 of the delayed input generally corresponds to the pulse width of the pulse 512 but is shifted by the time delay 524. In one example, at least one of the buffers 402 and 404 can generate a DC offset 516 between the input waveform 510 and the delayed input waveform 520 such that the voltage of the input waveform has a higher DC voltage offset relative to the delayed input waveform 520. The DC offset 516 can ensure that the voltage of the input waveform 510 is greater than the delayed input voltage between pulses to avoid pulse that may be inadvertently generated, e.g., as a result of optical and/or electrical noise that may be introduced into the waveforms 510 and 520.

The input waveform 510 and the delayed input waveform 520 are input to the comparator 306, which in the present example is configured to output a detector output waveform 530 having a high signal (or binary ‘1’ or first specified voltage) when the input signal is greater than the delayed input signal and to output a low signal (or binary ‘0’ or a second specified voltage that is less than the first specified voltage) when the input signal is less than the delayed input signal. In some examples, the comparator 306 can be configured to output a low signal (or binary ‘0’ or first specified voltage) when the input signal is greater than the delayed input signal and to output a low signal (or binary ‘1’ or a second specified voltage that is greater than the first specified voltage) when the input signal is less than the delayed input signal.

As shown in FIG. 5, when the media 136 has been advanced in the direction indicated by the arrow 140 such that the sensor 122 is aligned with the leading edge 508b of the label 504b, the label 504b blocks or attenuates the light signal output by the emitter of the sensor 122 such that the receiver of the sensor 122 does not detect the light signal or detects the light source with a substantially low intensity (e.g., the receiver detects light within a first range of values) and the pulse 512 of the input waveform 510 ends and the waveform returns to its steady state value. Because the delayed input is delayed by the time delay 524, the pulse 522 of the delayed waveform 520 continues after the sensor 122 is aligned with the leading edge 508b of the label 504b such that the falling edge of the pulse 512 of the input waveform 510 intersects with the pulse 522 of the delayed input waveform 520 at a time 526 which corresponds with the leading edge 508b of the label 504b causing the comparator 306 to output a pulse 532 on the detector output waveform 530 to the logic circuit 104 with a falling edge that is representative of detection of the leading edge 508b of the label 504b. Thereafter, the voltage of the input waveform is less than the voltage of the delated input waveform until a time 528 where a falling edge of the pulse 522 intersects the input waveform 510, which causes the comparator to return to the high voltage. Upon receiving the falling edge of detector output waveform 530, the logic circuit 104 can determine that a leading edge of a label has been detected.

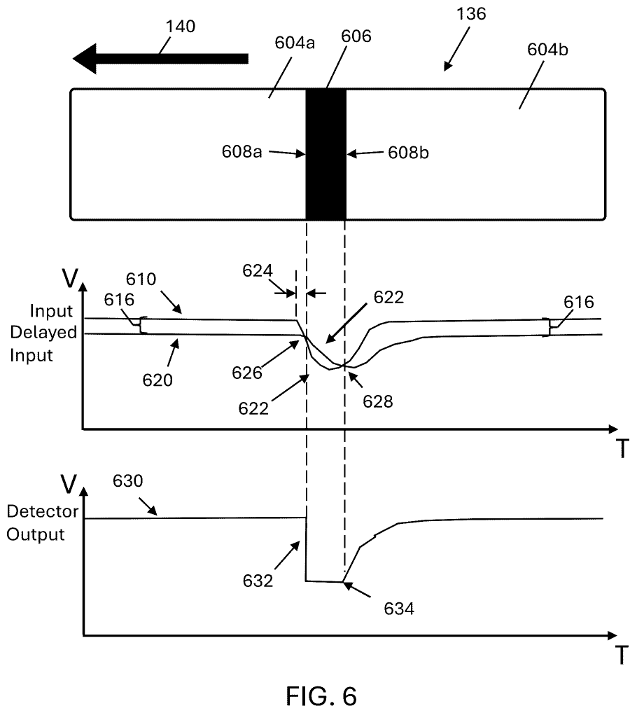

FIG. 6 illustrates an example operation of an embodiment of the detector 124 shown in FIG. 4. An example of the media 136 is shown that includes a continuous web of media units, e.g., labels 604a and 604b, providing printable areas separated by a black mark 606. The media 136 is advanced along a print path in the direction indicated by arrow 140 such that the label 604a passes the sensor 122 first and the label 604b passes the sensor after the label 604a. The sensor 122 can be used detect the black mark 606 between the labels 604a and 604b. For example, as the media 136 is advanced, a leading edge 608a of the black mark 606 aligns with the sensor and then passes the sensor in the direction indicated by the arrow 140. In one example, the light signal output by the emitter of the sensor 122 is reflected by the labels 604a and 604b when the sensor is aligned with the labels 604a and 604b such that the receiver of the sensor detects the light signal with a first intensity (or within a first range of intensity values).

As the media 136 is advanced and the black mark 606 aligns with the sensor 122, the light signal output by the emitter of the sensor 122 is reflected by the black mark 606 and the receiver of the sensor 122 detects the light signal with a second intensity that is lower than the first intensity (or within a second range of intensity values that are lower than the first range) or may no longer detect the light signal. As a result, the sensor output forms a waveform that generates a pulse, which in the present example, is a decrease in the voltage output by the receiver in response to a reduced intensity of the light signal impinging upon the receiver (or no light signal impinging on the receiver). The sensor output is processed in parallel by the buffer 402 of the signal processing path 302a and by the buffer 404 and the delay 406 of the signal processing path 302b. The output of the buffer 404 generates an input waveform 610 and the output of the buffer 404 and the delay 406 generates a delayed input waveform 620 which correspond to the input waveform but is delayed by a time delay 624 (which may correspond to a phase shift from the input waveform to the delayed input waveform). A width of a pulse 612 of the input waveform generally corresponds to a time it takes the media to be advanced from a point where the leading edge 608a of the black mark 606 aligns with the sensor 122 (a falling edge of the pulse 612) to a point where the trailing edge 508b of the black mark 606 aligns with the sensor 122 (a rising edge of the pulse 612), while a pulse 622 of the delayed input generally corresponds to the pulse width of the pulse 612 but is shifted by the time delay 624. In one example, at least one of the buffers 402 and 404 can generate a DC offset 616 between the input waveform 610 and the delayed input waveform 620 such that the voltage of the input waveform has a higher DC voltage offset relative to the delayed input waveform 620. The DC offset 616 can ensure that the voltage of the input waveform 610 is greater than the delayed input voltage between pulses to avoid pulse that may be inadvertently generated, e.g., as a result of optical and/or electrical noise that may be introduced into the waveforms 610 and 620.

The input waveform 610 and the delayed input waveform 620 are input to the comparator 306, which in the present example is configured to output a detector output waveform 630 having a high signal (or binary ‘1’ or first specified voltage) when the input signal is greater than the delayed input signal and to output a low signal (or binary ‘0’ or a second specified voltage that is less than the first specified voltage) when the input signal is less than the delayed input signal. In some examples, the comparator 306 can be configured to output a low signal (or binary ‘0’ or first specified voltage) when the input signal is greater than the delayed input signal and to output a low signal (or binary ‘1’ or a second specified voltage that is greater than the first specified voltage) when the input signal is less than the delayed input signal.

As shown in FIG. 6, when the media 136 has been advanced in the direction indicated by the arrow 140 such that the sensor 122 is aligned with the trailing edge 608b of the black mark 606, the label 504b reflects the light signal output by the emitter of the sensor 122 such that the receiver of the sensor 122 again detects the light signal with the first intensity (or within the first range of intensity values) and the pulse 612 of the input waveform 610 ends and the waveform 610 returns to its steady state value. Because the delayed input is delayed by the time delay 624, the falling edge of the pulse 612 of the input waveform 610 intersects with the delayed input waveform 620 at a time 626 which corresponds with the leading edge 608a of the black mark 606 causing the comparator 306 to output a pulse 632 on the detector output waveform 630 to the logic circuit 104 with a falling edge that is representative of detection of the leading edge 608a of the black mark 606. Thereafter, the voltage of the input waveform 510 is less than the voltage of the delated input waveform until a time 628 where a rising edge of the pulse 612 intersects the pulse 622 of the delayed input waveform 610, which causes the comparator to return to the high voltage. Upon receiving the falling edge of detector output waveform 630, the logic circuit 104 can determine that a leading edge of a black mark 606 has been detected.

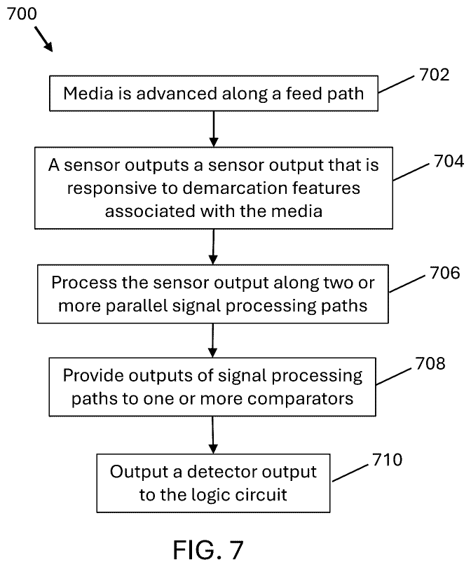

FIG. 7 is a flowchart illustrating an example process 700 for detecting a leading and/or trailing edge of a media unit, a printable area, or a demarcation feature in a media processing device (e.g., media processing device 100 shown in FIG. 1) in accordance with embodiments of the present disclosure. At operation 702, media is advanced along a feed path of the media processing device (e.g., by operation of the platen 120 shown in FIG. 1) via control from a logic circuit (e.g., logic circuit 104 shown in FIG. 1). At operation 704, a sensor (e.g., sensor 122 shown in FIG. 1) outputs a sensor output that responds to demarcation features by transitioning from a first value or range of values to a second value or range of values. At operation 706, the sensor output is provided as an input to a detector (e.g., detector 124 shown in FIG. 1), which processes the sensor output using two parallel signal processing paths. At least one of the signal processing paths (e.g., signal processing paths 302a-n shown in FIG. 3) can introduce a delay to the sensor output. At operation 708, the two or more signal processing paths provide their outputs to one or more comparators (e.g., one or more comparators 306), and at operation 710, the comparator(s) can output a detector output to the logic circuit, which can use the detector output for locating a leading and/or trailing edge of a media unit, a printable area, or a demarcation feature. The detector output can generate a pulse in response to processing a response in the sensor output that corresponds to the demarcation feature and a leading or trailing edge of the pulse can correspond to the leading or trailing edge of a media unit, a printable area, and/or a demarcation feature.

The above description refers to diagrams of the accompanying drawings. Alternative implementations of the example represented by the diagrams include one or more additional or alternative elements, processes, and/or devices. Additionally, or alternatively, one or more of the example elements of the diagram may be combined, divided, re-arranged, or omitted.

The above description refers to a block diagram of the accompanying drawings. Alternative implementations of the example represented by the block diagram includes one or more additional or alternative elements, processes, and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software, and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged, or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device”can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A media processing device, comprising:
a platen;
a printhead configured to form a nip with the platen roller;
a sensor disposed proximate to the printhead, the sensor configured to be responsive to demarcation features on a media supply as the media supply is advanced along a feed path past the sensor by the platen; and
a detector configured to receive a sensor output from the sensor, detect edges of the demarcation features, and output a detector output based on the detected edges; and
a logic circuit, the logic circuit configured to:
receive the detector output from the detector;
determine when to print based on the detector output; and
control the printhead and the platen to print on the media unit or printable area.

2. The media processing device of claim 1, wherein the detector includes at least two signal processing paths arranged in parallel with each other.

3. The media processing device of claim 2, wherein the detector includes a comparator configured to receive outputs from the at least two signal processing paths and the comparator is configured to output the detector output, the detector output including a pulse indicating that a leading or trailing edge of a media unit, a printable area, or one of the demarcation features has been detected by the detector.

4. The media processing device of claim 3, wherein at least one of the at least two signal processing paths includes a delay.

5. The media processing device of claim 3, wherein a first one of the at least two signal processing paths includes a delay and a second one of the at least two signal processing paths is devoid of a delay.

6. The media processing device of claim 3, wherein at least one of the at least two signal processing paths includes a buffer.

7. The media processing device of claim 1, wherein the demarcation feature comprises at least one of a gap or a notch, and when the demarcation feature aligns with the sensor, a light signal of the sensor passes through the demarcation feature and impinges upon a receiver of the sensor causing a change in voltage of the sensor output, the sensor output is processed in parallel by a first signal processing path of the detector that includes a first buffer and outputs a first intermediate signal and a second signal processing path of the detector that includes a second buffer and a delay and outputs a second intermediate signal.

8. The media processing device of claim 7, wherein the first intermediate first intermediate signal and the second intermediate signal have a DC voltage offset relative to each other.

9. The media processing device of claim 7, wherein the first intermediate signal and the second intermediate signal are input to a comparator of the detector, the comparator being configured to output the detector output having a first specified voltage when the first intermediate signal is greater than the second intermediate signal and to output a second specified voltage when the first intermediate signal is less than the second intermediate signal.

10. The media processing device of claim 9, wherein the first intermediate signal includes a first pulse that corresponds in time to the sensor output when the demarcation feature is aligned with the sensor and the second intermediate signal includes a second pulse that corresponds to the sensor output with a time delay.

11. The media processing device of claim 10, wherein the detector output from the comparator outputs a third pulse when a voltage value of the first intermediate signal is less a voltage value of the second intermediate signal.

12. The media processing device of claim 11, wherein the voltage value of the first intermediate signal is greater than the voltage value of the second intermediate signal until a falling edge of the first pulse occurs.

13. The media processing device of claim 11, wherein a falling edge of the third pulse corresponds to a leading edge of the media unit or the printable area adjacent to the demarcation feature.

14. The media processing device of claim 11, wherein a falling edge of the third pulse corresponds to a leading edge of the demarcation feature.

15. A method comprising:
advancing media along a feed path of a media processing device via control from a logic circuit;
outputting a sensor output from a sensor that responds to demarcation features of the media by transitioning from a first value or range of values to a second value or range of values;
providing the sensor output as an input to a detector, the detector processes the sensor output using at least two parallel signal processing paths;
providing intermediate outputs of the two or more signal processing paths to a comparator;
outputting a detector output to the logic circuit from the comparator, the logic circuit using the detector output to locate a leading edge or a trailing edge of a media unit, a printable area, or a demarcation feature of the media.

16. The method of claim 15, further comprising:
generating a pulse in the detector output in response to a response in the sensor output that corresponds to the demarcation feature.

17. The method of claim 16, wherein the falling edge of the pulse corresponds to a leading edge of the media unit, the printable area, or the demarcation feature.

18. The method of claim 15, wherein the demarcation feature comprises at least one of a gap or a notch, and when the demarcation feature aligns with the sensor, a light signal of the sensor passes through the demarcation feature and impinges upon a receiver of the sensor causing a change in voltage of the sensor output, and the method comprises
processing the sensor output in parallel by a first signal processing path of the detector that includes a first buffer and outputs a first intermediate signal and a second signal processing path of the detector that includes a second buffer and a delay and outputs a second intermediate signal.

19. The method of claim 18, further comprising:
offsetting a DC voltage of the first intermediate signal and the second intermediate signal.

20. The method of claim 19, wherein the first intermediate signal and the second intermediate signal are input to a comparator of the detector, the comparator being configured to output the detector output having a first specified voltage when the first intermediate signal is greater than the second intermediate signal and to output a second specified voltage when the first intermediate signal is less than the second intermediate signal.
